(19) United States
(12) Patent Application Publication
(10) Pub. No.: US 2002/0121172 A1
(43) Pub. Date: Sep. 5, 2002

(54) Device for perforating material webs

(76) Inventors: Serge Lanvin, Cires Les Mello (FR); Jean Francois Robert, Creil (FR)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/994,394

(22) Filed: Nov. 26, 2001

(30) Foreign Application Priority Data
Nov. 29, 2000 (DE) DE 100 59 125.6

(51) Int. Cl. B26F 1/22; B26D 11/00; B41F 13/56

(52) U.S. Cl. 83/862; 83/867; 83/678; 101/224

(57) ABSTRACT

A perforating tool for perforating single or multiple layer material webs or sheets (1) that are separated therefrom, including a first half (16) and a second half (17). In a first half (16), a multiplicity of perforating teeth (15) is accommodated; in the first half is also located a tool-free gap (18). In the second half (17) of the perforating tool (15) is a cutting zone (19) as well as groups (22) of perforating elements that are configured in alternating sequential fashion, which are angled with respect to the perforating tool.

Priority to German Patent Application No. 100 59 125.6, which is hereby incorporated by reference herein, is hereby claimed.

### BACKGROUND OF THE INVENTION

The present invention relates to a device for perforating material webs which can be composed of one or more layers and from which sheets are separated for further processing.

PCT Patent Application No. WO 00/10899 relates to a method and a device for perforating material webs. In accordance with this method and this device, sheets are separated from the forward end of a material web before transverse or longitudinal folding. The material web can be composed of one layer or of a plurality of web strands. Along the direction of travel of the material web, two cutting or perforating-and-cutting devices are arranged one after the other. Using a cutting unit, assigned to the first longitudinal fold, the material web strand is cut in this area. A further perforating/cutting device begins to perforate and cut the material web strand in the area of a transverse fold, while creating material bridges. At least one of the cutting and perforating tools can be adjusted relative to the material web strand.

French Patent Application No. 2,693,403 relates to a folded sheet, which can be used for producing brochures, books, or the like, a tool for creating perforations, as well as a method for generating them. Using an appropriately configured perforating knife, it is possible to generate incisions on at least one half of the sheet, the incisions partially running perpendicular with respect to the extension of the folded spine. As a result of the incisions in at least one half of the folded spine, it is possible to absorb the thrust of the inner layers of the folded sheet acting upon the exterior sheet layers, so that no deformations in the folded spine area can arise on the external layers of the sheet.

U.S. Pat. No. 4,951,967 relates to a perforating knife for signatures, as well as a signature that is produced using it. A signature, i.e., a sheet, is composed of a number of individual layers of sheets, which are arranged along a folding line. Along the folding line, across its width, a row of perforations is provided, set apart from each other. The rows of perforations set apart from each other are generated using a perforating knife, which has a number of perforating segments that are set apart from each other. In a sheet that is folded in this manner, bulges at the folded spine are avoided when a multiplicity of sheets is stacked.

U.S. Pat. No. 5,524,930 relates to a perforating knife as well as to a sheet. A perforating knife surrounds a single-piece sheet, which in relation to its length is very thin. On one longitudinal side of the perforating knife, a cutting area is configured; on the longitudinal side, it contains, in combination, a row of straight sections, that are set apart from each other, and sections that are executed in an angled fashion. The angled sections are arranged such that they are disposed so as to point to the center of the perforating knife, and they are configured only on one half of the perforating knife. According to one embodiment, a longer cutting segment is provided in the center of the perforating knife, adjacent to which in an alternating arrangement are three angled sections and one straight section. The angled sections are executed so that they point in one direction, so that, on the folding line being created on the folded sheet, incisions are made which point only in one direction. The incisions that are made form easily movable segments, which in turn create the folding lines, i.e., the folded spine on the sheet, which are folded smoothly without causing creases or bulges. The angled segments can be either straight or curved as long as they generally point to the center of the perforating knife and are only located on one side of the perforating knife.

If 48-page, 64-page, or 96-page sheets are produced on web-processing rotary printing machines, then the possibility becomes increasingly important of compensating for shearing, i.e. transverse, stress on the interior layers of the individual sheets with respect to the exterior sheet layers, so as not to impair the quality of the sheet in the further processing.

### SUMMARY OF THE INVENTION

The present invention is based on the objective, especially in multilayer folded sheets, to permit in the area of the folded spine relative motions of the interior sheet layers with respect to exterior sheet layers.

The present invention provides a perforating tool for perforating single or multiple layer material webs or sheets (1) separated therefrom, the perforating tool including a first half (16) and a second half (17). The perforating tool includes: (a) a number of perforating teeth (15) accommodated in the first half (16) of the perforating tool; (b) a tool-free gap (18) configured in the first half (16); (c) a cutting zone (19) arranged in the second half (17); and (c) at least one group (22), arranged in the second half (17) in alternating sequential fashion, of perforating elements (22.1, 22.2, 22.3) that are angled with respect to the perforating tool (15).

The advantages of the solution according to the present invention can be seen primarily in the fact that the folded spines of multilayer folded sheets can be provided on one side with pointwise perforation openings, so that air can exit, and that, on the other side, the other half of the folded spine to be created in the sheet can be provided, in each case, with incisions which permit a relative motion of the individual layers of the multilayer folded sheets with respect to each other. Thanks to the configuration of the individual incision-producing perforating knife tongues as angled surfaces, the incisions manifest themselves in a length of cut that is dependent on the material web strand, in accordance with the thickness of the material web strand to be perforated. In this manner, it is assured that in the case of 48-, 64-, and even 96-page sheets, the incisions are produced to a depth that permits a relative motion of the inner layers of the multilayer folded sheets relative to the outer layers of the folded sheet. The perforating tool proposed in accordance with the present invention is mounted on attachment devices of perforated cylinders, so that it can be easily replaced after extended use.

In a further embodiment of the idea underlying the present invention, a tool-free gap is arranged in the area of a first half of the perforating tool, the gap bordering on a cutting tool in the second half of the perforating tool. As a result of the tool-free area of the perforating knife configured in accordance with the present invention, in the central area of multilayer sheets a material bridge is produced which stabilizes the folding sheet, which advantageously contains a plurality of layers.

In an advantageous embodiment of the perforating knife configuration according to the present invention, the cutting zone in the second half of the perforating knife, on one side, borders on the tool-free gap in the first half of the perforating tool and, on the other side, borders on a first group of angled perforating tongues in the second half of the perforating tool that is configured in accordance with the present invention. In this manner, in folded spines of multilayer folded sheets, a longitudinal incision is introduced into the folded spine next to the material bridges formed by the tool-free gap, the folded spine for its part acting in the central area of the sheet to adjust the shearing stresses that arise. The perforating elements, advantageously configured as perforating tongues, of the individual groups of perforating elements on the second half of the perforating tool, are slanted with respect to the perforating tool at an angle of between 20° and 40°. It is particularly preferred that the angle of inclination of the individual perforating tongues of the groups of perforating elements be 30°.

The individual groups of slanted perforating elements, configured preferably as perforating tongues, are disposed within the second half of the perforating tool configured in accordance with the present invention, in an alternating sequence with respect to the cutting segments, so that in this half of the folded spine it is possible to form incisions that make possible a reduction in the shearing stress and as well as to produce incisions that are configured parallel to the folded spine.

In one embodiment variant, the groups of perforating elements accommodated in the second half of the perforating tool configured in accordance with the present invention are angled, the angle being symmetrical with respect to the planes of the perforating tool. In this embodiment variant of the perforating elements, both their front as well as their rear edge are angled with respect to the plane of the cutting tool.

In further embodiment possibilities of the perforating knife proposed in accordance with the present invention, individual perforating tongues within the second half of the perforating tool can be angled so that only the rear edge of the perforating tongues is angled with respect to the plane of the perforating tool. Similarly, it is also possible to configure a slant of the perforating tongues within the groups of perforating elements so that only their front edge is angled with respect to the plane of the perforating tool, and the rear edge essentially lies in the plane of the second half of the perforating tool. All embodiment variants have in common the circumstance that the individual perforating tongues of the groups of the perforating elements within the second half of the perforating tool configured in accordance with the present invention are angled with respect to the plane of the perforating tool at an angle of between 20° and 40°, but especially preferably at 30°.

The incisions that make possible the adjustment of shearing stresses within multilayer folded sheets in their folded spine area are preferably generated by slanted perforating elements arranged in groups, which are configured as perforating tongues. The individual perforating tongues of the groups of perforating elements are separated from each other by longitudinal slits, so that each of the perforating tongues has assigned to it a free space, through which the paper dust inevitably generated by the perforating and cutting of multilayer material webs can be carried away without accumulating.

The individual perforating elements in one preferred embodiment can be provided at their points with a slanted surface which ends in a perforating tongue point. The incisions to be produced in multilayer material webs for adjusting the shearing stresses in one half of the folded spine can be produced in a particularly precise manner if first a pointwise contact is generated between the incision-producing perforating tongues in the tip area of the perforating tongues, in response to contacting the upper side of the multilayer material web. As a result of the slanted surface running downward in an angle of inclination from the perforating tongue point, it is possible to adjust the incision length in the folded spine area of the multilayer folded sheet as a function of the penetration depth of the perforating tongue into the specific multilayer material web.

The embodiment of a perforating tool proposed according to the present invention is preferably accommodated on perforating cylinders, which are arranged in a folding apparatus of web-processing rotary printing machines. In this context, it is unimportant whether the web-processing rotary printing machine is a jobbing web-fed rotary printing machine or a newspaper rotary printing machine.

### BRIEF DESCRIPTION OF THE DRAWINGS

The present invention is described below in greater detail on the basis of the drawings, in which:

FIG. 1 depicts the lateral displacement at the open ends of the sheet occurring when the sheet is folded,

FIG. 2 depicts the top view of a sheet to be folded, on one half of which are produced the incisions that are to be created in accordance with the present invention,

FIG. 3 depicts a top view of one embodiment of the perforating tool proposed in accordance with the present invention,

FIG. 4 depicts a group of slanted perforating elements in an enlarged representation, and

FIGS. 5.1, 5.2, 5.3 and 5.4 depict further embodiments of one half of the perforating knife proposed in accordance with the present invention.

### DETAILED DESCRIPTION

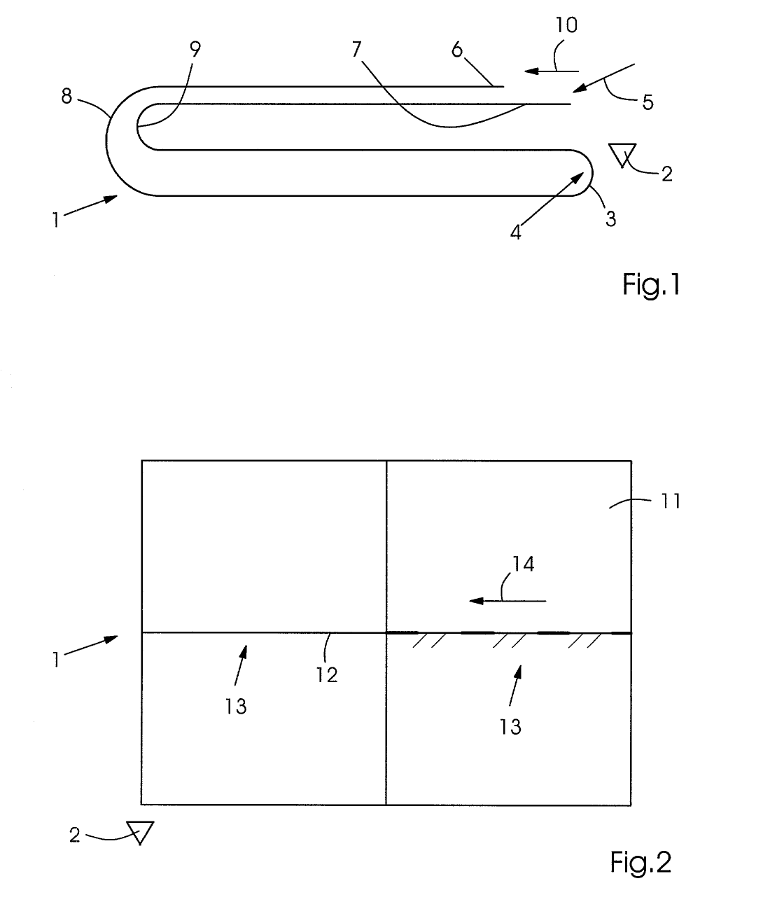

From the representation in FIG. 1 can be seen more clearly the lateral displacement of individual sheet layers of a multilayer sheet on the open side of the folded sheet, the displacement occurring when the sheet is folded.

Sheet 1 to be folded, depicted in FIG. 1, is aligned with respect to a reference line 2. Situated at reference line 2 is closed end 3 of sheet 1 to be folded, of which in representation 1 only the exterior sheet layer is depicted. Reference numeral 4 designates the interior side of the folded spine created at closed end 3 of sheet 1 to be folded. The exterior layer of sheet 1 to be folded, i.e., upper open side 6, is turned back at exterior curvature radius 8, whereas lower open side 7 of folded sheet 1 is turned back at a smaller curvature radius 9. As a result of different radii 8 and 9 on sheet 1, there is a displacement 10 at open end 5 of sheet 1, which is caused by the displacement of upper open side 6 relative to lower open side 7. This effect is more pronounced, the more layers the sheet to be processed contains.

The representation according to FIG. 2 depicts in greater detail the top view of a sheet to be folded, on one half of which the incisions to be created according to the present invention are configured for adjusting the shearing stress.

Sheet 1 to be folded, according to the representation in FIG. 2, is depicted in its unfolded state 11, arrow 14 indicating the direction in which a displacement 10 will arise at open end 5 of sheet 1 to be folded, resulting from the displacement of upper open side 6 with respect to lower open side 7 of multilayer sheet 1. Whereas along folded edge 12 a perforation pattern 13 is created made up of point-shaped perforation openings, the area of folded edge 12, running underneath depicted arrow 14 designating the directions of displacement, has a perforation pattern 13 which is characterized by incisions that are slanted with respect to the center of the sheet. The individual incisions all run towards the center of unfolded sheet 11 and make possible a shearing stress adjustment in the area of folded edge 12 of the sheet.

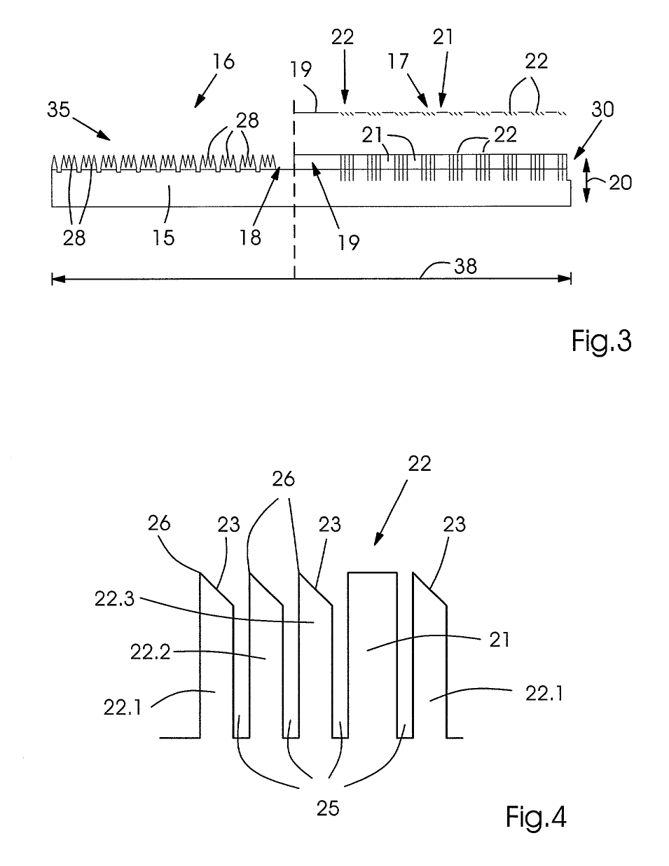

The representation according to FIG. 3 depicts a top view of a first embodiment variant of the perforating tool proposed in accordance with the present invention, in the form of a perforating knife.

Perforating tool 15, seen depicted in FIG. 3, can be divided into two halves 16 and 17 with respect to an imaginary center line represented by a dotted line.

The configuration of first half 16 of perforating tool 15 is characterized by a regular sequence of perforating teeth 28 acting in pointwise fashion on the folded spine in this area, the perforating teeth being arranged in continuous repetition 35 over the length of first half 16. Perforating teeth 28, acting in pointwise fashion upon the folded spine of a multilayer sheet, introduce in folded spine 1 openings through which air can escape that is trapped in the folded spine, puffing out the spine, so that even in the case of multilayer sheets a folded spine can be produced that is free of trapped air.

Adjacent to the continuous sequence of perforating teeth 35 in first half 16 of perforating tool 15 is a tool-free area 18. Tool-free area 18 makes it possible to create a material bridge in the center of a multilayer folded sheet. The material bridge, which is generated on first half 16 of perforating tool 15 in accordance with the selected depth of tool-free gap 18, stabilizes the folded spine of the multilayer sheet in the area of its center.

In second half 17 of perforating tool 15, proposed in accordance with the present invention, a cutting zone 19 is configured. Cutting zone 19 is immediately adjacent to tool-free gap 18 in first half 16 of perforating tool 15, and it extends to a first group 22 of slanted perforating elements. Using cutting zone 19, a partial incision is produced in the folded spine adjacent to the material bridge generated in the multilayer sheet by tool-free gap 18.

Adjacent to cutting zone 19, which extends continuously, is a first group 22 of slanted perforating elements. Behind first group 22 of slanted perforating elements, which are preferably configured as longitudinal slits of perforating tongues that are separated from each other, is a straight segment 21, which is configured as a cutting knife. Cutting knife area 21 and groups 22 of slanted perforating elements are accommodated in alternating sequential fashion in second half 17 of perforating tool 15, configured in accordance with the present invention. The perforating knife configured according to the present invention extends over a width 38 which advantageously corresponds to the maximum material web format to be processed.

Depicted in FIG. 3 above the side view of perforating tool 15 that is configured according to the present invention is a top view both of straight cutting edges 21 as well as of groups 22 of slanted perforating elements, arranged in alternating sequential fashion between them, the perforating elements advantageously being configured as perforating tongues. From the center line, depicted as a dotted line, extending to first group 22 is an elongated cutting zone 19. The height of perforating tool 15 according to the representation of FIG. 3 is characterized by reference numeral 20, it being possible to accommodate perforating tool 15, so as to be replaceable, on lateral surfaces of perforating cylinders, for example, in folding apparatuses that process material webs. In this way, perforating tools, which are subject to a high degree of wear, can be replaced very rapidly and simply, so that the perforations on multilayer material webs can be generated in the required quality and precision.

In the representation according to FIG. 4, a group of slanted perforating elements is depicted in greater detail.

The top view depicted in enlarged dimensions in FIG. 4 of a group 22 of perforating elements—preferably perforating tongues—includes a first perforating tongue 22. 1, a second perforating tongue 22.2, and a third perforating tongue 22.3. The individual perforating tongues are separated from each other by longitudinal slits 25, which can act to lead away the paper dust arising during the perforating, so that it can be removed from the perforating area without accumulating. Adjacent to three perforating tongues 22.1, 22.2, 22.3 is a straight segment 21 that is also separated by a longitudinal slit 25, the upper edge of the segment being configured as a straight cutting edge. In addition to the embodiment depicted in FIG. 4 of a group 22 of slanted perforating elements having three perforating tongues, it is possible within one group 22 of perforating tongues on second half 17 of perforating tool 15 to have, for each group 22, only two or also a larger plurality, i.e., four or five, individual perforating tongues, separated from each other by longitudinal slits 25.

The perforating tongues run to a point 26, which is a part of a surface 23 that is formed so as to be slanted. Upon contact with the multilayer material web to be perforated, perforating tongue points 26 first meet the uppermost layer of the material web acting in pointwise fashion, so that the incisions produced by the perforating tongues in the direction of the center of the sheet to be folded or to be perforated end up having a length that is a function of the thickness, i.e., the number of layers of the individual material webs. The thicker the material webs to be folded or to be perforated, i.e., the more layers the sheet to be perforated contains at the folded spine, the longer the incisions will have to be configured on the sheet in one half of the folded spine in accordance with perforating pattern 13. The incision length is a function of the penetration depth into the multilayer material web of slanted surfaces 23 of perforating tongues 22.1, 22.2, 22.3 in second half 17 of perforating tool 15, configured in accordance with the present invention.

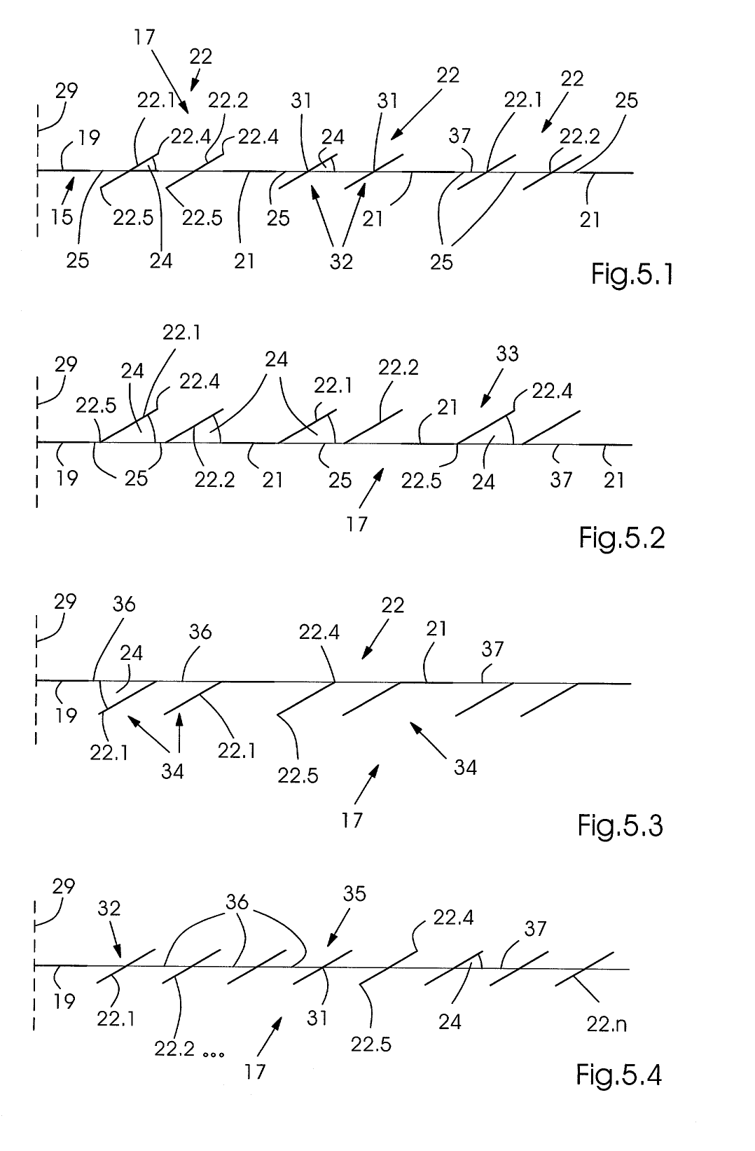

From the representations according to FIGS. 5.1 through 5.4, alternate embodiments of second half 17 of perforating tool 15, configured according to the present invention, are depicted in greater detail.

From the representation according to FIG. 5.1, it can be seen that in second half 17 of perforating tool 15 individual groups 22 of slanted perforating tongues are configured. In this embodiment, groups 22 of slanted perforating elements include only two perforating tongues 22.1 and 22.2. Individual perforating tongues 22.1 and 22.2 are separated from each other by longitudinal slits 25 and are uniformly angled with respect to a rotational axis 31, which coincides with reference line or longitudinal axis 37 on perforating tool 15, i.e., on front edge 22.5 and on rear edge 22.4 at angle of inclination 24 with respect to the plane of perforating tool 15. Angle of inclination 24, at which the perforating tongues are angled with respect to the plane of perforating tool 15, is preferably in the range between 20° and 40°. It is particularly preferable that angle of inclination 24 be 30°, the inclination of the front edge of perforating tongues 22.1 and 22.2 being selected with respect to the center of sheet 1 to be folded.

Since in the embodiment according to 5.1 both front edge 22.5 as well as rear edge 22.4 are symmetrically angled from the plane of perforating tool 15 with respect to axis of rotation 31 of each perforating tongue 22.1 and 22.2, the term symmetrical slant 32 is also used. Between groups 22 of slanted perforating elements, including in this embodiment only two perforating tongues 22.1 and 22.2, are individual cutting segments 21 parallel to reference line or longitudinal axis 37 on perforating tool 15. Groups 22 of slanted perforating tongues 22.1 and 22.2 as well as straight cutting segments 21 are positioned in second half 17 of perforating tool 15 in alternating sequential fashion.

In the embodiment variant according to FIG. 5.2, an alternative possible embodiment of second half 17 of perforating tool 15 is depicted in greater detail. In this embodiment, groups 22 of slanted perforating tongues 22.1, 22.2, adjacent to elongated cutting segment 19, are angled at their rear edge 22.4 with respect to the plane of perforating tool 15, whereas front edge 22.5 still lies straight in the plane of the perforating tool. In this angle pattern, an off-center displacement 33 of perforating tongues 22.1 and 22.2, angled with respect to the plane of perforating tool 15 and configured preferably as perforating tongues, results. Reference numeral 24 designates the angle of inclination, which in a particularly preferred configuration of a perforating tool is 30°. Situated, by analogy to the representation in FIG. 5.1, between individual perforating tongues 22.1 and 22.2, and separated by slit-shaped openings 25, are individual straight incisions 21, which are also separated from groups 22 of slanted perforating tongues 22.1, 22.2 by slit-shaped openings 25 running perpendicular to the plane of the drawing in accordance with the representation in FIG. 5.2. Groups 22 of slanted perforating tongues according to the embodiment variant in FIG. 5.2 also include only two perforating tongues. In addition, it is also of course possible to furnish individual groups 22 of slanted perforating elements with three or five or any number of perforating tongues. According to this angle pattern 33, front edges 22.5 of all individual perforating tongues 22.1 and 22.2 still lie in the plane of perforating tool 15.

Depicted in greater detail in the representation in FIG. 5.3 is a further embodiment of the arrangement of groups 22 of slanted perforating elements within second half 17 of a perforating tool 15 configured according to the present invention.

Adjacent to elongated cutting segment 19 are groups 22 of slanted perforating elements, which are interrupted in alternating sequence in each case by straight cutting segments 21 that lie in the plane of perforating tool 15. Reference line or longitudinal axis 37, in relation to which the perforating tongues are slanted at angle of inclination 24, is parallel to perforating tool 15. In the embodiment of the perforating tool according to the representation in FIG. 5.3, rear edges 22.4 of the individual perforating tongues, separated from each other by longitudinal slits 25, lie in the plane of perforating tool 15, whereas their front edges 22.5, in the top view according to the representation in FIG. 5.3, are slanted downwards. This embodiment also shows an off-center angle 34 of the individual perforating tongues of groups 22 of slanted perforating elements. As a result of this arrangement pattern of straight segments 21 and individual perforating tongues 22.1 and 22.2 of groups 22 of slanted perforating elements, longer free spaces 36 are formed between rear edges 22.4 of individual perforating tongues 22.1, 22.2, the free spaces later forming material bridges in the folded spine of the preferably multilayer folded sheet.

From the representation in FIG. 5.4, a further embodiment possibility of second half 17 of perforating tool 15 is depicted in greater detail. This embodiment is characterized by the fact that in second half 17 of the perforating tool, a multiplicity 22.1, 22.2 through 22.n of individual slanted perforating tongues is configured according to a fishbone pattern. The individual perforating tongues arranged in symmetrical slant 32 are interrupted by free spaces 36. Perforating tongues 22.1 through 22.n are each slanted about their axis 31 both at the front as well as at the rear edge with respect to reference line or longitudinal axis 37 of perforating tool 15. Here as well, the result is a continuous repetition of perforating tools over half 17 of the perforating knife. All the perforating tongues arranged in continuous repetition are angled with respect to the perforating tool plane about an angle 24 with regard to reference line 37. The angle of inclination is preferably in the range between 20° and 40°, an angle of inclination of 30° being particularly preferred.

Using the embodiment of the perforating tool proposed in accordance with the present invention according to FIGS. 3, 5.1, 5.2, 5.3, and 5.4, it is possible on one half of a folded spine of a folded sheet composed of a plurality of layers to introduce incisions as a function of the strength, i.e., the number of layers of the sheet, the incisions making possible a shearing stress adjustment of the inner sheet layers relative to the outer sheet layers, so that folded spines 4 can be configured overall in a more planar fashion and lateral displacement 10 of the individual layers with respect to each other can be significantly reduced at the open end of multilayer folded sheet 1.

Reference Numeral List

1 sheet

2 reference line

3 closed end

4 folded spine

5 open end

6 upper open side

7 lower open side

8 outer curvature

9 inner curvature

10 displacement

11 unfolded sheet surface

12 folded edge

13 perforation pattern

14 direction of displacement

15 perforating tool

16 first half or section

17 second half or section

18 tool- or perforation-free gap

19 cutting zone

20 height extension

21 cutting segment

22 group of perforating elements

22.1 first perforating tongue

22.2 second perforating tongue

22.3 third perforating tongue

22.4 rear edge

22.5 front edge

23 slanted surface

24 angle of inclination

25 slit-shaped opening

26 perforating tongue point

27 —

28 continuous perforating teeth

29 center line

30 free space

31 axis of rotation

32 symmetrical angle

33 off-center angle

34 off-center angle front edge

35 continuous repetition

36 free space

37 reference line; longitudinal axis

38 width perforating tool

What is claimed is:

1. A perforating tool for perforating single or multiple layer material webs or sheets separated therefrom, the perforating tool comprising:
a first section having a plurality of perforating teeth and a perforation-free gap; and
a second section having a cutting zone and at least one group of perforating elements in alternating sequential fashion, the perforating elements being angled with respect to a longitudinal axis of the second section.

2. The perforating tool as recited in claim 1 wherein the perforation-free gap of the first section borders on the cutting zone of the second section.

3. The perforating tool as recited in claim l wherein the cutting zone borders, on one side, on the perforation-free gap and, on the other side, on the group of perforating elements.

4. The perforating tool as recited in claim 1 wherein the perforating elements of the group are angled in relation to the axis at an angle of between 2020 and 40°.

5. The perforating tool as recited in claim 4 wherein the angle is 30°.

6. The perforating tool as recited in claim 1 wherein the at least one group includes two groups and the second section further includes cutting segments, in alternating sequential fashion, between the groups.

7. The perforating tool as recited in claim 1 wherein the perforating elements at a front edge and at the rear edge are symmetrically angled with respect to the axis.

8. The perforating tool as recited in claim 1 wherein the perforating elements at a rear edge are angled on one side with respect to the axis.

9. The perforating tool as recited in claim 1 wherein the perforating elements at a front edge are inclined with respect to the axis.

10. The perforating tool as recited in claim 1 wherein the slanted perforating elements are configured as perforating tongues.

11. The perforating tool as recited in claim 10 wherein the individual perforating elements of the group of perforating elements are separated by slit-shaped openings.

12. The perforating tool as recited in claim 1 wherein the perforating elements of the group have a slanted surface at tips of the perforating elements.

13. The perforating tool as recited in claim 1 wherein a length of the first section and a length of the second section are the same.

14. A perforating device in a folding apparatus arranged downstream of a web-processing rotary printing machine, having a perforating tool as recited in claim 1.

15. A perforating tool for perforating single or multiple layer material webs or sheets separated therefrom, the perforating tool comprising:
a first section having a plurality of perforating teeth and a perforation-free gap; and
a second section having a cutting zone and a plurality of perforating elements angled with respect to the perforating tool and arranged in the second section in sequential rows.
